(19) United States
(12) Patent Application Publication
(10) Pub. No.: US 2016/0232151 A1
(43) Pub. Date: Aug. 11, 2016

(54) RESPONSIVE COURSE DESIGN SYSTEM AND METHOD

(71) Applicant: TRIVANTIS CORPORATION, INC., Boca Raton, FL (US)

(72) Inventor: John Blackmon, Boca Raton, FL (US)

(21) Appl. No.: 14/620,022

(22) Filed: Feb. 11, 2015

(51) Int. Cl. G06F 17/24

(52) U.S. Cl. CPC G06F 17/248

(57) ABSTRACT

A system and method is provided of creating web based content that provides an optimal viewing experience across phones, tablets, and desktop browsers, with a simple creation interface for the author based on device type and orientation. Traditional responsive design bases layout on flowing content based upon the width of the device screen it is viewed on. Responsive Course Design bases layout strictly on device type and orientation, defining three device types, Phone, Tablet, and Desktop, and two orientations, Portrait, and Landscape. All content will have its width scaled to fit exactly the same when viewed on a device category, so that an author will be able to determinately know what the content will look like on that device no matter what the width of the screen.

### BACKGROUND OF THE INVENTION

1. Field of the Invention

The field of art disclosed herein pertains to web content development systems and more particularly to displaying of web content in different display formats.

2. Description of the Related Art

Responsive web design (RWD) is an approach to web design aimed at crafting sites to provide an optimal viewing experience—easy reading and navigation with a minimum of resizing, panning, and scrolling—across a wide range of devices (from desktop computer monitors to mobile phones). A site designed with RWD adapts the layout to the viewing environment by using fluid, proportion-based grids, flexible images, and CSS3 media queries, an extension of the @media rule, in the following ways: (i) The fluid grid concept calls for page element sizing to be in relative units like percentages, rather than absolute units like pixels or points; (ii) Flexible images are also sized in relative units, so as to prevent them from displaying outside their containing element; and (iii) Media queries allow the page to use different Cascading Style Sheets (CSS) style rules based on characteristics of the device the site is being displayed on, most commonly the width of the browser.

CSS is a style sheet language used for describing the look and formatting of a document written in a markup language. While most often used to change the style of web pages and user interfaces written in HTML and XHTML, the language can be applied to any kind of XML document, including plain XML, SVG and XUL. Along with HTML and JavaScript, CSS is a cornerstone technology used by most websites to create visually engaging webpages, user interfaces for web applications, and user interfaces for many mobile applications.

CSS is designed primarily to enable the separation of document content from document presentation, including elements such as the layout, colors, and fonts. This separation can improve content accessibility, provide more flexibility and control in the specification of presentation characteristics, enable multiple HTML pages to share formatting by specifying the relevant CSS in a separate .css file, and reduce complexity and repetition in the structural content, such as semantically insignificant tables that were widely used to format pages before consistent CSS rendering was available in all major browsers. CSS makes it possible to separate presentation instructions from the HTML content in a separate file or style section of the HTML file. For each matching HTML element, it provides a list of formatting instructions. For example, a CSS rule might specify that “all heading 1 elements should be bold,” leaving pure semantic HTML markup that asserts “this text is a level 1 heading” without formatting code such as a <bold> tag indicating how such text should be displayed.

This separation of formatting and content makes it possible to present the same markup page in different styles for different rendering methods, such as on-screen, in print, by voice (when read out by a speech-based browser or screen reader) and on Braille-based, tactile devices. It can also be used to display the web page differently depending on the screen size or device on which it is being viewed. While the author of a web page typically links to a CSS file within the markup file, readers can specify a different style sheet, such as a CSS file stored on their own computer, to override the one the author has specified. If the author or the reader did not link the document to a style sheet, the default style of the browser will be applied.

The CSS specification describes a priority scheme to determine which style rules apply if more than one rule matches against a particular element. In this so-called cascade, priorities or weights are calculated and assigned to rules, so that the results are predictable. The CSS specifications are maintained by the World Wide Web Consortium (W3C). Internet media type (MIME type) text/css is registered for use with CSS by RFC 2318 (March 1998). The W3C operates a free CSS validation service for CSS documents.

Products on the market today are very complicated to use. All use width based “breakpoints” which does not allow you to know what it will look like on a certain device category. In a BYOD (bring your own device) world, devices all have different logical widths, and use CSS point based scaling to display on high resolution screens.

Current implementations of Responsive Design all work by using a columnar approach to flowing content based on screen width. This works in a situation where you always know the screen width of the target device, for example if all content was viewed on a single brand of phone. Current devices are using quite a variety of screen widths, so it is impossible to determine what your content will look like on a given device, unless you research every device and find out its screen width.

It is only deterministic in a situation where you always know the screen width of the target device, for example if all content was viewed on a single brand of phone. Current devices are using quite a variety of screen widths, so it is impossible to determine what your content will look like on a given device, unless you research every device and find out its screen width.

### BRIEF DESCRIPTION OF THE FIGURES

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1 illustrates a diagrammatic view of an information handling system (IHS) for Responsive Course Design (RCD), according to one or more embodiments;

FIG. 2 illustrates a flow diagram of a method of previewing RCD content in one of several generic formats by the IHS of FIG. 1, according to one or more embodiments; and

FIG. 3 illustrates a flow diagram of a method of developing RCD content in one of the several generic formats by the IHS of FIG. 1, according to one or more embodiments.

### DETAILED DESCRIPTION

The present disclosure provides in one aspect a method of creating web based content that provides an optimal viewing experience across phones, tablets, and desktop browsers, with a simple creation interface for the author based on device type and orientation. Traditional responsive design bases layout on flowing content based upon the width of the device screen it is viewed on. Responsive Course Design bases layout strictly on device type and orientation, defining three device types, Phone, Tablet, and Desktop, and two orientations, Portrait, and Landscape. All content will have its width scaled to fit exactly the same when viewed on a device category, so that an author will be able to determinately know what the content will look like on that device no matter what the width of the screen.

Turning now to the Drawings, the detailed description set forth below in connection with the appended drawings is intended as a description of various configurations and is not intended to represent the only configurations in which the concepts described herein may be practiced. The detailed description includes specific details for the purpose of providing a thorough understanding of various concepts with like numerals denote like components throughout the several views. However, it will be apparent to those skilled in the art that these concepts may be practiced without these specific details. In some instances, well known structures and components are shown in block diagram form in order to avoid obscuring such concepts.

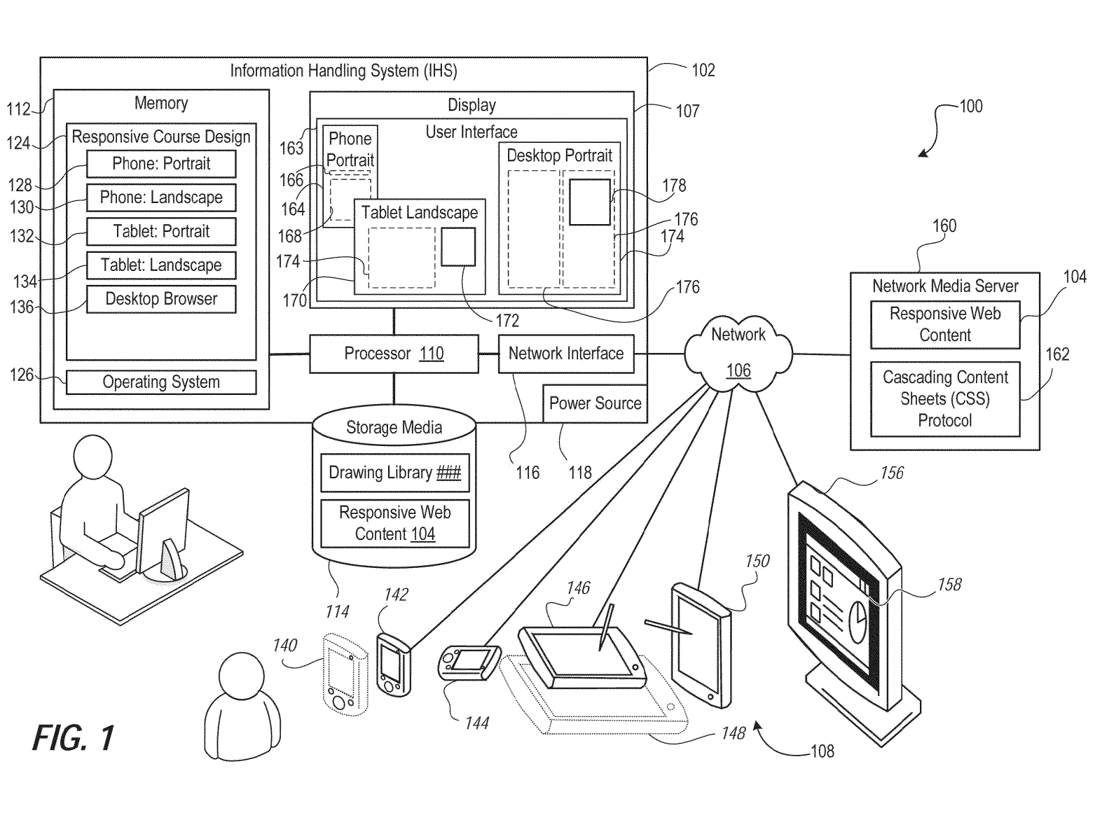

FIG. 1 illustrates a communication system 100 including an information handling system (IHS) 102 for designing, previewing and distributing responsive web content 104 over a network 106. The IHS 102 can preview on a display 107 the responsive web content 104 that is being designed for one or several generic types of user devices 108. Thereby, the responsive web content 104 can be validated without necessarily replicating or emulating an exhaustive range of display sizes and resolutions. For purposes of this disclosure, an information handling system, such as IHS 102, may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a handheld device, personal computer, a server, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

In a particular embodiment, the IHS 102 includes a processor 110, a memory 112 communicatively coupled to processor 110, storage media 114, a network interface 116 communicatively coupled to processor 110, and a power source 118 electrically coupled to processor 110. Processor 110 may include any system, device, or apparatus configured to interpret and/or execute program instructions and/or process data, and may include, without limitation a microprocessor, microcontroller, digital signal processor (DSP), Application Specific Integrated Circuit (ASIC), or any other digital or analog circuitry configured to interpret and/or execute program instructions and/or process data. In some embodiments, processor 110 may interpret and/or execute program instructions and/or process data stored in memory 112 and/or another component of IHS 102. Memory 112 may be communicatively coupled to processor 110 and may include any system, device, or apparatus configured to retain program instructions and/or data for a period of time (e.g., computer-readable media). By way of example without limitation, memory 112 may include RAM, EEPROM, a PCMCIA card, flash memory, magnetic storage, opto-magnetic storage, or any suitable selection and/or array of volatile or non-volatile memory that retains data after power to IHS 102 is turned off or power to IHS 102 is removed. Network interface 116 may include any suitable system, apparatus, or device operable to serve as an interface between IHS 102 and network 106. Network interface 116 may enable the IHS 102 to communicate over network 106 using any suitable transmission protocol and/or standard, including without limitation all transmission protocols and/or standards enumerated herein with respect to the discussion of network 106.

In one or more embodiments, the processor 110 access response web content 104 that includes objects 120 from a drawing library 122 in the storage media 114. A responsive course design (RCD) utility 124 that is resident in memory 112 with an operating system 126 and executed by processor 110 allows a user to position the responsive web content 104 in more than one generic format that can include Phone: Portrait format 128, Phone: Landscape format 130, Tablet: Portrait format 132, Tablet: Landscape format 134, and desktop browser format 136. The formats are chosen to be representative of a number of user devices 108 rather than replicating the display size and resolution exactly. For example, user devices 108 can include a large phone 140 that is viewed in portrait mode, a small phone 142 that is held in portrait mode, a small phone 144 that is held in landscape mode, a small tablet 146 that is held in landscape mode, a large tablet 148 that is held in landscape mode, a tablet 150 that is held in portrait mode, and a desktop monitor 15 that presents a browser 158.

The user devices 108 represent a range of display sizes and CSS point resolutions such as the following phones, tablets, and browsers:

iPhone 4: 320×480;

iPhone 5,5S: 320×568;

iPhone 6: 375×667;

iPhone 6+: 414×736;

Chrome browser in GS3,4,5: 360×640;

Standard browser in GS3,4: 720×1280;

Galaxy Note 3 360×640;

Fire Phone: 360×640;

Lumia 635: 357×595;

Lumia 1520: 487×866;

iPad: 1024×768;

iPad Mini: 1024×768;

iPad Air: 1024×768;

Nexus 10: 1280×752;

Samsung Galaxy Tab 4 (8 inch) 962×601;

Samsung Galaxy Tab 10.1 1280×800; and

LG GPad (7 inch) 911×601.

The network 106 can distribute responsive web content 104 that is remotely stored on a network media server 160 by using CSS protocol 162 to query the media being used by the user devices 108 to distribute the responsive web content 104 in an appropriate format type. The display 107 in a user interface 163 approximates what the responsive web content 104 will be viewed by an end user. For example, a depicted phone portrait emulation 164 can include a link 166 to an object and a single, small column 168 for text data. A depicted tablet landscape emulation 170 can include an object 172 and a larger column for text data. A depicted desktop portrait emulation 174 can include elongated pair of columns 176 and an enlarged object 178 inserted into the columns 176.

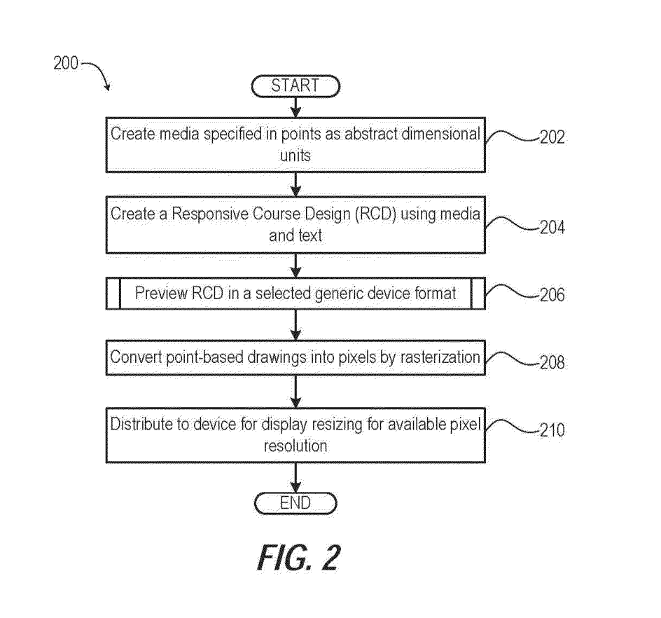

FIG. 2 illustrates a method 200 of previewing RCD content in one of several generic formats by the IHS, according to one or more embodiments. The method 200 includes creating media specified in points as abstract dimensional units (block 202). At the beginning, coordinates of all drawings are specified in points that are abstract units. The drawings only make sense in this mathematical coordinate space. The method includes 200 includes creating a Responsive Course Design (RCD) using media and text (block 204). An IHS presents a preview of the RCD in a selected generic device format (block 206). The RCD is rendered by type of device. Present innovation uses only the device type and orientation to determine the layout, and then scales the layout to fit the exact width of the device. Design is for device type and orientation and not screen width. For example, the types can encompass one or more of five possible views: Phone Portrait, Phone Landscape, Tablet Portrait, Tablet Landscape, and Desktop. The RCD are converted to point-based drawings into pixels by rasterization (block 208). Point coordinates are multiplied by scale factor to get pixel coordinates. Higher scale factors result in higher level of detail. IHS distributes pixelated drawings to a device for display that resizes for available pixel resolution (block 210). The device screen may have lower pixel resolution than the image rendered in previous step. Before the image can be displayed, it must be downsampled (resized) to lower pixel resolution. Finally, computed pixels are displayed on the physical screen. The pixels per inch (PPI) number tells you how many pixels fit into one inch and thus how large the pixels appear in the real world.

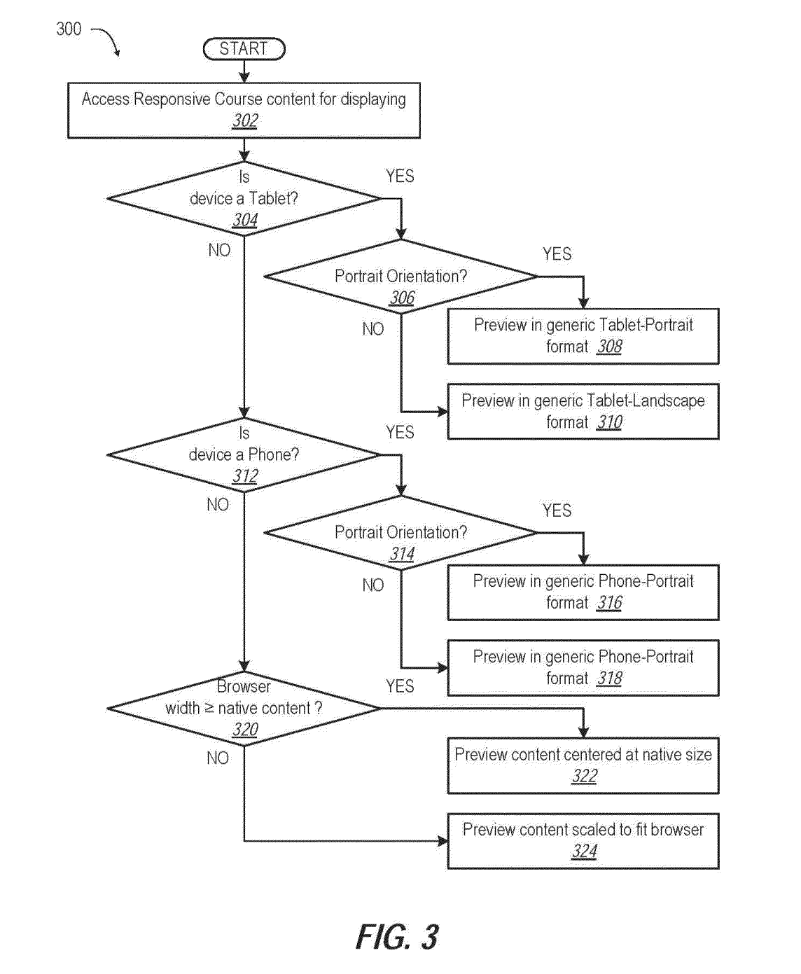

FIG. 3 illustrates a method 300 for previewing RCD in one or several formats. Method 300 begins at start block. Method 302 includes accessing response course content for displaying (block 302). A determination is made as to whether the type of device is a tablet (decision block 304). In response to determining in decision block 304 that the type of device is a tablet, then a further determination is made as to whether the tablet device is displaying in a portrait orientation (decision block 306). In response to determining in decision block 306 that the tablet device is displaying in a portrait orientation, then the method 300 includes previewing in generic tablet-portrait format (block 308). In response to determining in decision block 306 that the tablet device is not displaying in a portrait orientation, then the method 300 includes previewing in generic tablet-landscape format (block 310).

In response to determining in decision block 304 that the type of device is not a tablet, then a further determination is made as to whether the device is a phone (decision block 312). In response to determining in decision block 312 that the type of device is a phone, then a further determination is made as to whether the phone device is displaying in a portrait orientation (decision block 314). In response to determining in decision block 314 that the phone device is displaying in a portrait orientation, then the method 300 includes previewing in generic phone-portrait format (block 316). In response to determining in decision block 306 that the phone device is not displaying in a portrait orientation, then the method 300 includes previewing in generic phone-landscape format (block 318).

In response to determining in decision block 312 that the type of device is not a phone, then a further determination is made as to whether the browser has a width that equal to or greater than the native content (decision block 320). In response to determining in decision block 320 that the browser has a width that equal to or greater than the native content, then method 300 includes previewing content centered at native size (block 322). In response to determining in decision block 320 that the browser has a width that is less than the native content, then method 300 includes previewing content scaled to fit the browser (block 324). Then method 300 ends.

In one or more embodiments, themes are not needed, but if used, can be automatically switched for each defined view. Tablet and Phone views can scale to fit the exact width of the screen. Desktop views will center if the browser width is greater than the view width, and will scale if the browser width is smaller. Images/Videos/Buttons/etc. are scaled. Text fonts are adjusted. Text block widths are scaled and heights adjusted. Every object can be individually moved and sized in any view. All properties of an object can be changed for any view. Objects can be added or removed from any view.

In the above described flow charts of FIGS. 2-3, one or more of the methods may be embodied in a computer readable device containing computer readable code such that a series of functional processes are performed when the computer readable code is executed on a computing device. In some implementations, certain steps of the methods are combined, performed simultaneously or in a different order, or perhaps omitted, without deviating from the scope of the disclosure. Thus, while the method blocks are described and illustrated in a particular sequence, use of a specific sequence of functional processes represented by the blocks is not meant to imply any limitations on the disclosure. Changes may be made with regards to the sequence of processes without departing from the scope of the present disclosure. Use of a particular sequence is therefore, not to be taken in a limiting sense, and the scope of the present disclosure is defined only by the appended claims.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. Computer program code for carrying out operations for aspects of the present disclosure may be written in any combination of one or more programming languages, including an object oriented programming language, without limitation. These computer program instructions may be provided to a processor of a general purpose computer, special purpose computer, such as a service processor, or other programmable data processing apparatus to produce a machine, such that the instructions, which execute via the processor of the computer or other programmable data processing apparatus, performs the method for implementing the functions/acts specified in the flowchart and/or block diagram block or blocks.

All publications, patents and patent applications cited herein, whether supra or infra, are hereby incorporated by reference in their entirety to the same extent as if each individual publication, patent or patent application was specifically and individually indicated as incorporated by reference. It should be appreciated that any patent, publication, or other disclosure material, in whole or in part, that is said to be incorporated by reference herein is incorporated herein only to the extent that the incorporated material does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein, will only be incorporated to the extent that no conflict arises between that incorporated material and the existing disclosure material.

It must be noted that, as used in this specification and the appended claims, the singular forms “a,” “an” and “the” include plural referents unless the content clearly dictates otherwise. Thus, for example, reference to a “colorant agent” includes two or more such agents.

Unless defined otherwise, all technical and scientific terms used herein have the same meaning as commonly understood by one of ordinary skill in the art to which the invention pertains. Although a number of methods and materials similar or equivalent to those described herein can be used in the practice of the present invention, the preferred materials and methods are described herein.

References within the specification to “one embodiment,” “an embodiment,” “embodiments”, or “one or more embodiments” are intended to indicate that a particular feature, structure, or characteristic described in connection with the embodiment is included in at least one embodiment of the present disclosure. The appearance of such phrases in various places within the specification are not necessarily all referring to the same embodiment, nor are separate or alternative embodiments mutually exclusive of other embodiments. Further, various features are described which may be exhibited by some embodiments and not by others. Similarly, various requirements are described which may be requirements for some embodiments but not other embodiments.

It is understood that the use of specific component, device and/or parameter names and/or corresponding acronyms thereof, such as those of the executing utility, logic, and/or firmware described herein, are for example only and not meant to imply any limitations on the described embodiments. The embodiments may thus be described with different nomenclature and/or terminology utilized to describe the components, devices, parameters, methods and/or functions herein, without limitation. References to any specific protocol or proprietary name in describing one or more elements, features or concepts of the embodiments are provided solely as examples of one implementation, and such references do not limit the extension of the claimed embodiments to embodiments in which different element, feature, protocol, or concept names are utilized. Thus, each term utilized herein is to be given its broadest interpretation given the context in which that terms is utilized.

As will be appreciated by one having ordinary skill in the art, the methods and compositions of the invention substantially reduce or eliminate the disadvantages and drawbacks associated with prior art methods and compositions.

It should be noted that, when employed in the present disclosure, the terms “comprises,” “comprising,” and other derivatives from the root term “comprise” are intended to be open-ended terms that specify the presence of any stated features, elements, integers, steps, or components, and are not intended to preclude the presence or addition of one or more other features, elements, integers, steps, components, or groups thereof.

As required, detailed embodiments of the present invention are disclosed herein;

however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

While it is apparent that the illustrative embodiments of the invention herein disclosed fulfill the objectives stated above, it will be appreciated that numerous modifications and other embodiments may be devised by one of ordinary skill in the art. Accordingly, it will be understood that the appended claims are intended to cover all such modifications and embodiments, which come within the spirit and scope of the present invention.

1. A method of previewing responsive web content, the method comprising:
creating a display object scaled in an abstract dimension of points;
defining one or more generic device templates each having a vertical and horizontal display size of a selected number of points;
receiving a responsive course design of responsive web content containing text and the display object;
selecting one of one or more generic device templates that approximates pixel width rendering of the responsive web content for more than one type of end user device each type having a differing display width and resolution; and
previewing the responsive course design in the selected one or more of the generic device templates.

2. The method of claim 1, wherein the one or more generic device templates are selected from a group consisting of phone portrait format, phone landscape format, tablet portrait format, tablet landscape format, and a browser format.

3. An information handling system, comprising:
a display;
a memory;
a processor in electronic communication with the display and memory; and
a responsive course design utility stored in memory and executed by the processor to:
create a display object scaled in an abstract dimension of points;
define one or more generic device templates each having a vertical and horizontal display size of a selected number of points;
receive a responsive course design of responsive web content containing text and the display object;
select one of one or more generic device templates that approximates pixel width rendering of the responsive web content for more than one type of end user device each type having a differing display width and resolution; and
preview on the display the responsive course design in one or more generic device templates.

4. The information handling system of claim 3, wherein the one or more generic device templates are selected from a group consisting of phone portrait format, phone landscape format, tablet portrait format, tablet landscape format, and a browser format.

5. The method of claim 1, further comprising:
in response to the preview of the display, modifying the selected one of one or more generic device templates; and
storing the modified selected one of the one or more generic device templates for specific pixel width rendering by each receiving device.

6. The method of claim 5, further comprising accessing response web content that includes objects from a drawing library.

7. The method of claim 6, further comprising accessing a responsive course design (RCD) utility that allows a user to position the responsive web content in more than one generic format.

8. The information handling system of claim 3, wherein the responsive course design utility stored in the memory and executed by the processor to:
in response to the preview of the display, modify the selected one of one or more generic device templates; and
store the modified selected one of the one or more generic device templates for specific pixel width rendering by each receiving device.

9. The information handling system of claim 8, further comprising a network and network interface for allowing the processor to access response web content that includes objects from a drawing library held in storage on the network.

10. The information handling system of claim 9, wherein the network can distribute responsive web content that is remotely stored on a network media server.
